(19) United States
(12) Patent Application Publication
(10) Pub. No.: US 2005/0219204 A1
(43) Pub. Date: Oct. 6, 2005

(54) Interactive display system

(76) Inventors: Wyatt Huddleston, Philomath, OR (US); Michael Blythe, Albany, OR (US); Shane Shivji, Corvallis, OR (US); Greg Blythe, Philomath, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/818,280

(22) Filed: Apr. 5, 2004

(51) Int. Cl. G09G 5/00

(52) U.S. Cl. 345/156

(57) ABSTRACT

An interactive display system is disclosed. The interactive display system includes a display surface and a digital light processor configured to project a plurality of pixels onto said display surface to generate a viewable image. The digital light processor is further configured to substantially simultaneously project encoded optical signals to said display surface such that said viewable image is not noticeably degraded.

### BACKGROUND

Interactive electronic display surfaces allow human users to use the display surface as a mechanism both for viewing content, such as computer graphics, video, etc., as well as inputting information into the system. Examples of interactive display surfaces include common touch-screens and resistive whiteboards, for example. A whiteboard is analogous to a conventional chalkboard, except that a user “writes” on the whiteboard using an electronic hand-held input device that may look like a pen. The whiteboard is able to determine where the “pen” is pressing against the whiteboard and the whiteboard displays a mark wherever the “pen” is pressed against the whiteboard.

Conventional interactive display surfaces are capable of communicating with a single input device at any given time. That is, conventional interactive display surfaces are not equipped to receive simultaneous inputs from multiple input devices. If multiple input devices were to provide input to the conventional interactive display surface at the same time, errors would likely occur because the interactive display device would not be able to discern one input device from another. Thus, conventional interactive display surfaces are limited to function with a single input device at any given time.

The present invention was developed in light of these and other drawbacks.

### BRIEF DESCRIPTION OF THE DRAWINGS

The present invention will now be described, by way of example, with reference to the accompanying drawings, in which:

FIG. 1 illustrates an interactive display system according to an embodiment;

FIG. 2 is an exploded view of the interactive display system in FIG. 1;

FIG. 3 is a close-up view of a portion of a digital light processor, according to one embodiment, used in the interactive display system shown in FIGS. 1 and 2; and

FIG. 4 is a logical schematic diagram of the interactive display system, according to an embodiment.

### DETAILED DESCRIPTION

An interactive display system is disclosed that facilitates optical communication between a system controller or processor and an input device via a display surface. The optical communication, along with a feedback methodology, enables the interactive display system to receive simultaneous input from multiple input devices. The display surface may be a glass surface configured to display an optical light image generated by a digital light projector (DLP) in response to digital signals from the controller. The input devices may take various forms, such as pointing devices, game pieces, computer mice, etc., that include an optical receiver and a transmitter of some sort. The DLP sequentially projects a series of visible images (frames) to the display surface to generate a continuous moving video or graphic, such as a movie video, a video game, computer graphics, Internet Web pages, etc. The DLP also projects subliminal optical signals interspersed among the visible images. The subliminal signals are invisible to the human eye. However, optical receivers within the input devices receive the subliminal optical encoded signals. In this way, the controller can communicate information to the input devices in the form of optical signals via the DLP and the interactive display surface. To locate the physical positions of input devices on the display surface, the controller can transmit a subliminal positioning signal over the display surface, using various methodologies. When an input device receives the subliminal positioning signal, the input device can send a unique feedback signal (using various techniques) to the controller, effectively establishing a “handshake” between the controller and the particular input device. As a result of the unique feedback signals, the controller knows where each of the input devices is located on the display surface and can individually establish simultaneous two-way communication with the input devices for the remaining portion of the image frame. Once the controller knows where the different input devices on the display surface are located, various actions can be taken, including effecting communication between the controller and the input devices, as well as effecting communication between the various input devices through the controller.

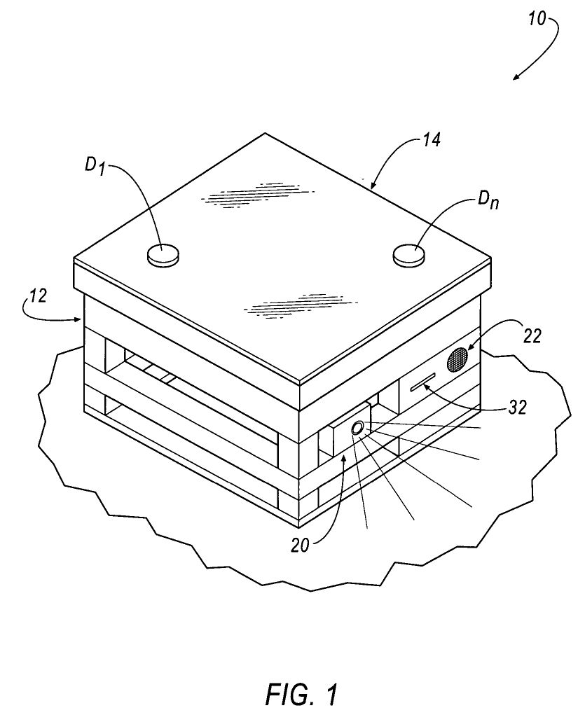

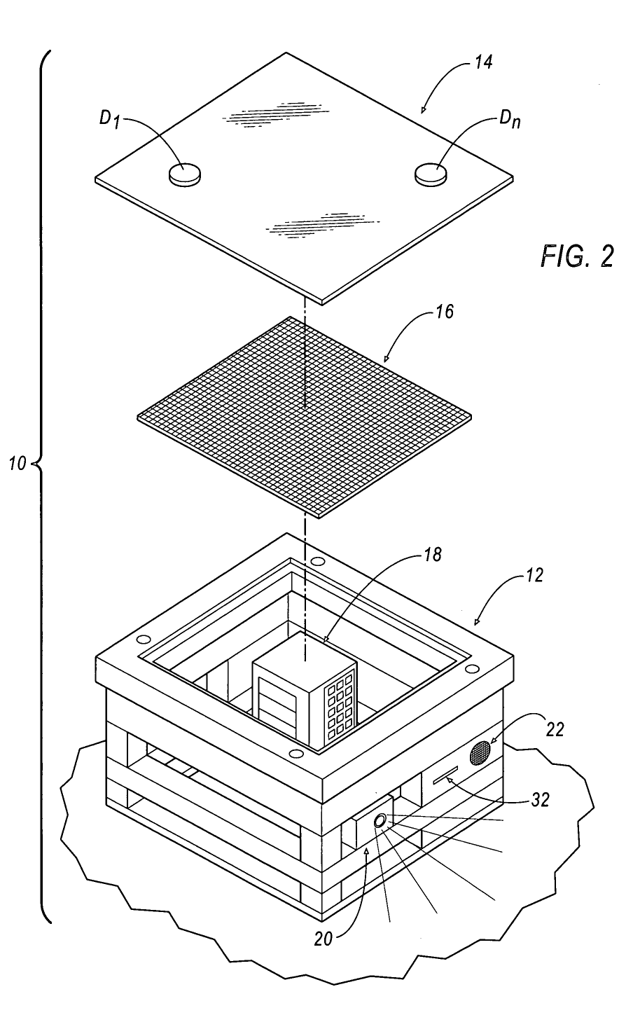

Referring now to FIGS. 1 and 2, an interactive display system 10 is shown according to an embodiment. In this particular embodiment, the interactive display system 10 is shown as embodied in a “table” 12, with the table surface functioning as the display surface 14. In this way, multiple users (each having his/her own input device) can view and access the display surface by sitting around the table. The physical embodiment, though, can take many forms other than a “table.”

With reference to FIGS. 1 and 2, the interactive display system 10 includes a display surface 14, a digital light processor (DLP) 16, and a controller 18. Generally, the controller 18 generates electrical image signals indicative of viewable images, such as computer graphics, movie video, video games, Internet Web pages, etc., which are provided to the DLP 16. The controller 18 can take several forms, such as a personal computer, microprocessor, or other electronic devices capable of providing image signals to a DLP. The DLP 16, in response to the electrical signals, generates digital optical (viewable) images on the display surface 14. The controller 18 may receive data and other information to generate the image signals from various sources, such as hard drives, CD or DVD ROMs 32, computer servers, local and/or wide area networks, and the Internet, for example. The controller 18 may also provide additional output in the form of projected images from an auxiliary projector 20 and sound from speaker 22.

The interactive display system 10 further includes one or more input devices, shown in FIGS. 1 and 2 as elements D₁ and D_{N}. Each input device has an outer housing and includes both a receiver and a transmitter, which are normally integrated into the input device. The receiver is an optical receiver configured to receive optical signals from the DLP 16 through the display surface 14. For example, the optical receiver may be a photo receptor such as a photocell, photo diode or a charge coupled device (CCD) embedded in the bottom of the input device. The transmitter, which is configured to transmit data to the controller 18, can take many forms, including a radio frequency (RF, such as Bluetooth™) transmitter, an infrared (IR) transmitter, an optical transmitter, a hardwired connection to the controller (similar to a computer mouse), etc. The input devices D₁, D_{N} can also take a variety of physical forms, such as pointing devices (computer mouse, white board pen, etc.), gaming pieces, and the like. The input devices D₁, D_{N} provide input information, such as their respective physical position on the display surface, etc., to the controller via their respective transmitters. The input devices D₁, D_{N} are configured to receive data from the DLP 16, such as positioning signals, via their respective receivers, as will be described in greater detail below. In some embodiments, the input devices may include components in addition to the receiver and the transmitter, such as a processor of some sort to interpret and act upon the signals received by the receiver and to drive the transmitter in transmitting information to the controller 18. Further, in another embodiment, each input device may include a light filter of some sort that only allows light of a certain color or intensity to pass through, which may be beneficial for interacting with the system to receive the encoded optical signals from the DLP.

As shown in FIG. 1 and 2, the interactive display system 10 can include a variety of other features, such as a projector 20, configured to simultaneously project the content on the display surface 14 onto a wall-mounted screen, for example. The interactive display system 10 may also include one or more speakers 22 for producing audible sounds that accompany the visual content on the display surface 14. The interactive display system 10 may also include one or more devices for storing and retrieving data, such as a CD or DVD ROM drive, disk drives, USB flash memory ports, etc.

The DLP 16 may take a variety of forms. In general, the DLP 16 generates a viewable digital image on the display surface 14 by projecting a plurality of pixels of light onto the display surface 14. It is common for each viewable image to be made up from millions of pixels. Each pixel is individually controlled by the DLP 16 to have a certain color (or grey-scale). The combination of many light pixels of different colors (or grey-scales) on the display surface 14 generates a viewable image or “frame.” Continuous video and graphics are generated by sequentially combining frames together, as in a motion picture.

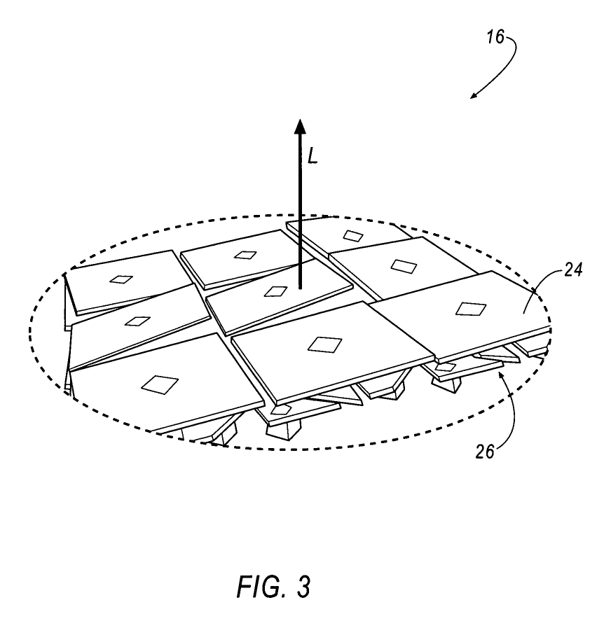

One embodiment of a DLP 16 includes a digital micro-mirror device (DMD) to project the light pixels onto the display surface 14. Other embodiments could include diffractive light devices (DLD), liquid crystal on silicon devices (LCOS), plasma displays, and liquid crystal displays to just name a few. Other spatial light modulator and display technologies are known to those of skill in the art and could be substituted and still meet the spirit and scope of the invention. A close-up view of a portion of an exemplary DMD is illustrated in FIG. 3. As shown, the DMD includes an array of micro-mirrors 24 individually mounted on hinges 26. Each micro-mirror 24 corresponds to one pixel in an image projected on the display surface 14. The controller 18 provides image signals indicative of a desired viewable image to the DLP 16. The DLP 16 causes each micro-mirror 24 of the DMD to modulate light (L) in response to the image signals to generate an all-digital image onto the display surface 14. Specifically, the DLP 16 causes each micro-mirror 24 to repeatedly tilt toward or away from a light source (not shown) in response to the image signals from the controller 18, effectively turning the particular pixel associated with the micro-mirror “on” and “off”, which normally occurs thousands of times per second. When a micro-mirror 24 is switched on more frequently than off, a light gray pixel is projected onto the display surface 14, and, conversely, when a micro-mirror 24 is switched off more frequently than on, a darker gray pixel is projected. A color wheel (not shown) may be used to create a color image, as known by a person skilled in the art. The individually light-modulated pixels together form a viewable image or frame on the display surface 14.

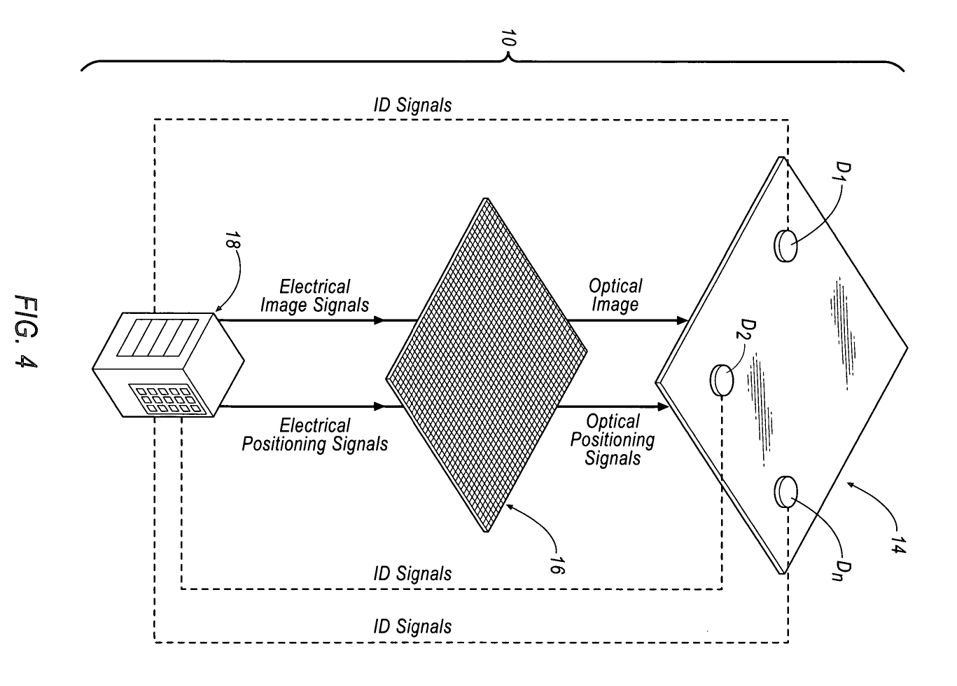

As shown in FIG. 4, the interactive display system 10 facilitates two-way communication between the controller 18 and the input devices D₁, D₂, D_{N}. In particular, each input device D₁, D₂, D_{N} transmits ID signals to the controller 18 via its transmitter. Each input device D₁, D₂, D_{N} receives signals from the controller 18 in the form of modulated optical signals (optical positioning signals) via the DLP 16, which is controlled by electrical positioning signals and electrical image signals from the controller 18. As indicated above, the transmitter of each input device D₁, D₂, D_{N} can send ID signals to the controller via a variety of mechanisms, including wireless RF, IR, or optical signals, hard-wiring, etc.

The optical signals received by the input devices D₁, D₂,D_{N} are transmitted by the DLP 16 interspersed among the visible optical images projected onto the display surface 14 in such a way that the optical signals are not discernable by the human eye. Thus, the visible image is not noticeably degraded. For instance, where the DLP 16 includes a DMD device, a given micro-mirror of the DMD can be programmed to send a digital optical signal interspersed among the repetitive tilting of the micro-mirror that causes a particular color (or grey-scale) to be projected to the display surface for each image frame. While the interspersed optical signal may theoretically alter the color (or grey-scale) of that particular pixel, the alteration is generally so slight that it is undetectable by the human eye. The optical signal transmitted by the DMD may be in the form of a series of optical pulses that are coded according to a variety of known encoding techniques.

Two-way communication between the controller 18 and each input device allows the interactive display system 10 to accommodate simultaneous input from multiple input devices. As described above, other known systems are not able to accommodate multiple input devices simultaneously providing input to the system because other systems are incapable of identifying and distinguishing between the multiple input devices. Two-way communication between the input devices D₁, D₂, D_{N} and the controller 18 allows the system to use a feed-back mechanism to establish a unique “handshake” between each input device D₁, D₂,D_{N} and the controller 18. In particular, for each frame (still image) generated on the display surface 14, the DLP 16 projects subliminal optical positioning signals to the display surface 14 to locate the input devices D₁, D₂, D_{N}, and, in response, the input devices D₁, D₂, D_{N} send feedback signals to the controller 18 to establish a “handshake” between each input device and the controller 18. This may occur for each frame of visible content on the display surface 14. In general, for each image frame, the controller 18 causes one or more subliminal optical signals to be projected onto the display surface 18, and the input devices D₁, D₂, D_{N} respond to the subliminal signals in such a way so that the controller 18 is able to uniquely identify each of the input devices D₁, D₂, D_{N}, thereby establishing the “handshake” for the particular frame.

The unique “handshake” can be accomplished in various ways. In one embodiment, the controller 18 can cause the DLP 16 to sequentially send out a uniquely-coded positioning signal to each pixel or group of pixels on the display surface 14. When the positioning signal is transmitted to the pixel (or group of pixels) over which the receiver of one of the input devices is positioned, the input device receives the optical positioning signal, and, in response, transmits a unique ID signal (via its transmitter) to the controller 18. The ID signal uniquely identifies the particular input device from which it was transmitted. When the controller receives a unique ID signal from one of the input devices in response to a positioning signal transmitted to a particular pixel, the controller 18 knows where that particular input device is positioned on the display surface. Specifically, the input device is positioned directly over the pixel (or group of pixels) that projected the positioning signal when the input device sent its feedback ID signal to the controller 18. In this way, a feedback “handshake” is established between each of the input devices on the display surface and the controller 18. Thereafter, the controller 18 and input devices can communicate with each other for the remaining portion of the frame—the controller can send optical data signals to the input devices via their respective associated pixels, and the input devices can send data signals to the controller 18 via their respective transmitters—and the controller will be able to distinguish among the various input signals that it receives during that frame. This process can be repeated for each image frame. In this way, the position of each input device on the display surface can be accurately identified from frame to frame.

The methodology for establishing the “handshake” for each of the input devices will now be described in more detail in the context of a system using two input devices D₁ and D₂. For each image frame generated by the DLP 16, the controller 18 causes the DLP 16 to sequentially project a unique positioning signal to each pixel (or group of pixels) on the display surface 14, i.e., one after another. The positioning signal can be sequentially transmitted to the pixels on the display surface 14 in any pattern—for example, the positioning signal could be transmitted to the pixels (or groups of pixels) row-by-row, starting at the top row of the image frame. The positioning signal projected to most of the pixels (or groups of pixels) will not be received by either of the input devices. However, when the positioning signal is projected to the pixel (or group of pixels) over which the receiver of the first input devices rests, the receiver of the first input device will receive the positioning signal, and the transmitter of the input device will transmit a unique ID signal back to the controller 18, effectively identifying the input device to the controller 18. In this way, the controller will know where the first input device is located on the display surface 14. Similarly, the controller will continue to cause the DLP 16 to project the subliminal positioning signal to the remaining pixels (or groups of pixels) of the image frame. As with the first input device, the second input device will transmit its own unique ID signal back to the controller 18 when it receives the positioning signal from the DLP 16. At that point, the controller 18 knows precisely where each of the input devices D₁, D₂ is located on the display screen. Therefore, for the remaining portion of the frame, the controller 18 can optically send information to each of the input devices by sending optical signals through the pixel over which the receiver of the particular input device is located. Similarly, for the remaining portion of the frame, each input device can send signals to the controller (via RF, IR, hardwire, optical, etc.), and the controller will be able to associate the signals that it receives with the particular input device that transmitted it and the physical location of the input device on the display surface 14.

Several variations can be implemented with this methodology for establishing a “handshake” between the input devices D₁, D_{N} and the controller 18. For instance, once the input devices are initially located on the display surface 14, the controller 18 may not need to transmit the positioning signal to all of the pixels (or groups of pixels) on the display surface in subsequent image frames. Because the input devices will normally move between adjacent portions of the display surface 14, the controller 18 may cause the subliminal positioning signals to be transmitted only to those pixels that surround the last known positions of the input devices on the display surface 14. Alternatively, multiple different subliminal positioning signals can be projected to the display surface, each coded uniquely relative to each other. Multiple positioning signals would allow faster location of the input devices on the display surface.

Another method may include sending the positioning signal(s) to large portions of the display surface at the same time and sequentially narrowing the area of the screen where the input device(s) may be located. For example, the controller 18 could logically divide the display surface in half and sequentially send a positioning signal to each of the screen halves. If the controller does not receive any “handshake” signals back from an input device in response to the positioning signal being projected to one of the screen halves, the controller “knows” that there is no input devices positioned on that half of the display surface. Using this method, the display surface 14 can logically be divided up into any number of sections, and, using the process of elimination, the input devices can be located more quickly than by simply scanning across each row of the entire display surface. This method would allow each of the input devices to be located more quickly in each image frame.

In another embodiment, once each of the input devices are affirmatively located on the display surface 14, the controller 18 could cause the DLP 16 to stop projecting image content to the pixels on the display surface under the input devices. Because the input devices would be covering these pixels anyway (and thus they would be non-viewable by a human user), there would be no need to project image content to those pixels. With no image content, all of the pixels under each of the input devices could be used continuously to transmit data to the input device. With no image content, the controller could transmit higher amounts of data in the same time frame.

The ability to allow multiple input devices to simultaneously communicate data to the system has a variety of applications. For example, the interactive display system can be used for interactive video/computer gaming, where multiple game pieces (input devices) can communicate with the system simultaneously. In one gaming embodiment, the display surface 14 may be set up as a chess board with thirty two input devices, each input device being one of the chess pieces. The described interactive display system allows each of the chess pieces to communicate with the system simultaneously, allowing the system to track the moves of the pieces on the board. In another embodiment, the display surface can be used as a collaborative work surface, where multiple human users “write” on the display surface using multiple input devices (such as pens) at the same time.

In another embodiment, the interactive display system can be used such that multiple users can access the resources of a single controller (such as a personal computer, including its storage disk drives and its connection to the Internet, for example) through a single display surface to perform separate tasks. For example, an interactive display system could be configured to allow each of several users to access different Web sites, PC applications, or other tasks on a single personal computer through a single display surface. For instance, the “table” of FIGS. 1 and 2 could be configured to allow four users to access the Internet independently of each other through a single personal computer device and a single display surface embedded in the “table.” Each user could carry on their own separate activities on the display surface through their own respective input devices (such as computer mice). The four different “activities” (Web pages, spreadsheets, video display, etc.) could be displayed at four different locations on the same display surface. In this way, multiple users can share a single controller (personal computer), a single image projection system (digital light processor) and a single display surface in a group setting (all users sitting around a “table”), while each user carries on his/her own separate activities with his/her own respective logical “work areas” on the common display surface.

In some embodiments, it may be useful for the various input devices positioned on the display surface to communicate with each other. This can be accomplished by communicating from one input device to another through the display surface. Specifically, once the various input devices are located on the display surface, a first input device can transmit data information to the controller 18 via its transmitter (such as, via infrared, radio frequency, hard wires, etc.), and the controller 18, in turn, can relay that information to a second input device optically, as described hereinabove. The second input device can respond to the first input device through the controller 18 in similar fashion.

While the present invention has been particularly shown and described with reference to the foregoing preferred and alternative embodiments, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

1. An interactive display system, comprising:
a display surface;
a digital light processor configured to project a plurality of pixels onto said display surface to generate a viewable image; and
wherein said digital light processor is further configured to substantially simultaneously project encoded optical signals to said display surface such that said viewable image is not noticeably degraded.

2. The interactive display system of claim 1, wherein said encoded optical signals are encoded pulses of light.

3. The interactive display system of claim 1, wherein said encoded optical signals are projected to pixels on said display surface that also display part of a viewable image substantially simultaneously.

4. The interactive display system of claim 1, further comprising an input device having an optical receiver configured to receive said encoded optical signals.

5. The interactive display system of claim 4, wherein said input device further includes a transmitter configured to transmit information to a controller.

6. The interactive display system of claim 5, wherein said input device is configured to transmit said information either via optical signals, infrared signals, radio frequency signals, or hard wires.

7. The interactive display system of claim 1, wherein said display device is a transparent surface.

8. The interactive display system of claim 1, wherein said display surface and said digital light processor are integrated into a table.

9. The interactive display system of claim 1, wherein said digital light processor includes a digital micro-mirror device.

10. The interactive display system of claim 1, further comprising a controller configured to cause said digital light processor to project said viewable images and said encoded optical signals to said display surface.

11. The interactive display system of claim 1, further comprising a plurality of input devices, each input device being configured to receive encoded optical signals from said digital light processor through said display surface.

12. The interactive display system of claim 11, wherein each said input device is configured to transmit an ID signal to a controller in response to said input device receiving a positioning signal from said digital light processor, said ID signal being configured to identify said input device from which it is transmitted.

13. The interactive display system of claim 1, further comprising a controller configured to drive the digital light processor and communicate with a plurality of input devices on said display surface.

14. A method for communicating with an input device positioned on a display surface, comprising:
projecting viewable images to a display surface; and
projecting encoded optical signals to the input device through said display surface substantially simultaneously with said viewable images.

15. The method of claim 14, wherein said step of projecting viewable images to a display surface includes modulating light to project a plurality of viewable pixels to said display surface.

16. The method of claim 15, wherein said encoded optical signals comprise light pulses interspersed with said viewable pixels.

17. A method for locating an input device on a display surface, comprising:
projecting an encoded optical positioning signal to the display surface substantially simultaneously with a viewable image; and
transmitting an ID signal from the input device to the controller in response to the input device receiving said positioning signal, said ID signal uniquely identifying the input device.

18. The method of claim 17, wherein multiple input devices are positioned on the display surface, and wherein each said input device transmits a unique ID signal to the controller in response to the respective input device receiving said positioning signal.

19. The method of claim 18, wherein said projecting step is repeated until all input devices on the display surface are located.

20. The method of claim 17, further comprising the step of transmitting information from the controller to only those pixels that surround the last known positions of the input devices on the display surface.

21. The method of claim 17, further comprising the step of transmitting multiple different encoded positioning signals, each coded uniquely relative to each other.

22. The method of claim 17, wherein the step of sending and encoded positioning signal further includes sending the encoded positioning signal to large portions of the display surface and sequentially narrowing the area of display surface to where input devices are located.

23. The method of claim 17, further comprising the step of displaying separate activities on the display surface to provide for multiple logical work areas.

24. The method of claim 17, further comprising the step of transmitting information from the controller to the input device as encoded optical data signals after the controller identifies the physical location of the input device on the display surface.

25. The method of claim 24, further comprising the step of ceasing projection of a portion of said viewable image on the display surface that is hidden from view by the input device on the display surface.

26. The method of claim 17, wherein said encoded optical positioning signal is projected to pixels on the display surface comprising a viewable image frame at least until the location of the input device on the display surface is identified by the controller.

27. The method of claim 26, wherein said encoded optical positioning signal is projected to an individual pixel on the display surface at a given time.

28. The method of claim 26, wherein said encoded optical positioning signal is projected to a group of pixels on the display surface at a given time.

29. The method of claim 26, wherein said optical positioning signal is projected sequentially to pixels or groups of pixels on the display surface.

30. The method of claim 29, wherein said optical positioning signal is projected to pixels or groups of pixels on the display surface in a row by row fashion.

31. The method of claim 17, further wherein said step of projecting said encoded optical positioning signal to pixels on the display surface is repeated for each image frame that comprises a moving image on the display surface.

32. An interactive display system, comprising:
a means for generating a viewable image comprised of a plurality of light pixels and for substantially simultaneously projecting encoded optical signals interspersed with said light pixels comprising said viewable image; and
a means for displaying said viewable image;

33. The interactive display of claim 32, further comprising one or more input devices physically located on said means for displaying said viewable image, each input device having a receiver configured to receive said encoded optical signals.

34. The interactive display of claim 33, wherein said input devices are further configured to transmit signals to a controller in response to receiving said encoded optical signal.

35. An input device for use with a display, comprising:
a housing;
an optical receiver; and
a transmitter, wherein said transmitter is configured to transmit a transmission signal in response to said optical receiver receiving an optically encoded signal through the display.

36. The input device of claim 35, wherein said optical receiver is one of a photocell, photo diode, or a charge coupled device.

37. The input device of claim 35, wherein said transmitter is one of an infrared transmitter, a radio frequency transmitter, an optical transmitter, or a hard-wired transmitter.

38. The input device of claim 35, further including a processor in electrical communication with said optical receiver and said transmitter.

39. The input device of claim 35, further including a light filter positioned in front of said optical receiver.

40. A method of communicating between two objects positioned on a display surface, comprising:
transmitting a transmission signal from a first object positioned on the display surface to a controller;
said controller causing an optical signal to be projected from a digital light processor to the display surface, said optical signal corresponding to said transmission signal; and
receiving said optical signal with a second object positioned on the display surface.

41. The method of claim 40, wherein said transmitting step comprises sending one of an infrared signal, a radio frequency signal, an optical signal and an electrical signal over wires.

42. The method of claim 40, wherein said optical signal is projected substantially simultaneously with viewable images on the display surface such that said viewable image is not noticeably degraded.

43. An interactive display system, comprising:
a display surface;
a digital light processor configured to project a plurality of pixels onto said display surface to generate multiple viewable images at different locations on the display surface to create logical work areas; and
wherein said digital light processor is further configured to substantially simultaneously project encoded optical signals to said display surface such that said multiple viewable images are not noticeably degraded.

44. The interactive display system of claim 43, further comprising at least one input device having an optical receiver configured to receive said encoded optical signals.

45. The interactive display system of claim 43, further including a controller coupled to the digital light processor wherein said at least one input device further includes a transmitter configured to transmit information to a controller.

46. The interactive display system of claim 45, wherein said controller restricts said at least one input device to at least one logical work area.
